(19) United States
(12) Patent Application Publication
(10) Pub. No.: US 2014/0054283 A1
(43) Pub. Date: Feb. 27, 2014

(54) INDUCTION HEATING WORKCOIL

(71) Applicants: Sylvain Larivé, Grand-Mere (CA); Christian Major, Grand-Mere (CA)

(72) Inventors: Sylvain Larivé, Grand-Mere (CA); Christian Major, Grand-Mere (CA)

(73) Assignee: Comaintel Inc., Grand-Mere,Quebec (CA)

(21) Appl. No.: 14/009,280

(22) PCT Filed: Apr. 4, 2012
(86) PCT No.: PCT/CA12/00287

§ 371 Date: Nov. 14, 2013

Related U.S. Application Data
(60) Provisional application No. 61/471,929, filed on Apr. 5, 2011.

(51) Int. Cl. H05B 6/42; D21G 1/02

(52) U.S. Cl. CPC H05B 6/42; D21G 1/028
USPC 219/619; 219/677

(57) ABSTRACT

An induction heating workcoil has a ferrite core on which are wound multiple layers of an electrically conductive material. To cool the winding, solid thermal conductors are inserted between the multiple layers of the winding to provide a thermal interface with the multiple layers. The workcoil can also have a hollow tube that is wound on the outside of the winding with the tube having a liquid circulating through it to cool the winding. The core can have a cross-shaped top and an I-shaped leg with the multiple layers of the winding wound on the leg of the core. The solid thermal conductors can extend above the height of the windings so that the heat to be dissipated is transferred to the upper portion of the workcoil. The multiple layers of the winding are tightly wound on the solid thermal conductors to maximize the thermal interface.

### FIELD OF THE INVENTION

The present invention relates to workcoils used in induction heating applications and to the internal dissipation of heat from such coils.

2. Description of the Prior Art

In a typical induction heating system used in applications such as pulp and paper calendering, rolling mills or similar converting applications, one or more induction heating workcoils, each having an associated power converter, are placed near a target load. The power converters apply a high frequency alternating current in the workcoils so that the load is heated by the variation of the electromagnetic field.

For web calendering applications, web thickness is controlled by applying heat to one or more rolls arranged in a stack, so that the resulting changes in roll diameter modifies the pressure in the nip formed between two rolls according to the process control requirements. The heating effect of the roll is also desired in some situations as the increase in roll temperature increases the quality of the finish of the paper, mainly gloss.

In web converting applications, the goal is to apply heat to a roll so that the material is altered or finished in a desirable fashion. Typical converting applications are laminating, embossing, heat-setting and corrugating.

In rolling mill applications, the goal is to apply heat to the edges of a roll so that its temperature becomes uniform. Due to the tremendous amount of heat generated by the rolling mill application, it is rarely desirable to apply heat to the entire roll. The temperature at the edge of the rolls tapers off very quickly and thus the speed of the machine must be slowed to prevent material loss. By applying external heat to the roll edges, it is possible to speed up the process and increase productivity.

As is well known the workcoils are made of electrical conductive windings and possibly one or more ferrite materials. Because of the harsh environment to which the workcoils are subjected the coils are usually encapsulated in epoxy type materials.

### SUMMARY OF THE INVENTION

An induction heating coil has a winding of multiple layers of an electrically conductive material wound on a ferrite core; and solid thermal conductors between the multiple layers of the winding to provide a thermal interface with the multiple layers for cooling the conductive material.

A system having: an induction profiler for indirectly heating a non-conductive sheet of material, the induction profiler has:

one or more induction heating coils, each of the one or more induction heating coils having:

a winding of multiple layers of an electrically conductive material wound on a ferrite core; and

solid thermal conductors between the multiple layers of the winding to provide a thermal interface with the multiple layers for cooling the conductive material.

A ferrite core for use in an induction heating workcoil has a cross-shaped top with a bottom surface and an I-shaped leg protruding downwardly from the bottom surface of the top.

### DESCRIPTION OF THE DRAWING

FIG. 1 shows a typical papermaking machine that includes an induction profiler.

FIG. 2 shows an induction workcoil presently used in paper, converting and metal rolling industries.

FIG. 3 shows a typical roll heating system that uses an induction workcoil.

FIG. 4 shows an embodiment for an induction workcoil where the multiple coil layers are wound on conductive heat channels.

FIG. 5 shows another embodiment for the induction workcoil where each of the coil layers are wound on thermally conductive spacers.

FIG. 6 shows another embodiment for the induction workcoil, using liquid cooling.

FIG. 7 shows another embodiment for the induction workcoil.

FIG. 8 shows the preferred ferrite core for the induction workcoil shown in FIGS. 4-7.

FIG. 9 shows the effect of coil size windings on the heat distribution provided by the induction workcoil.

### DETAILED DESCRIPTION

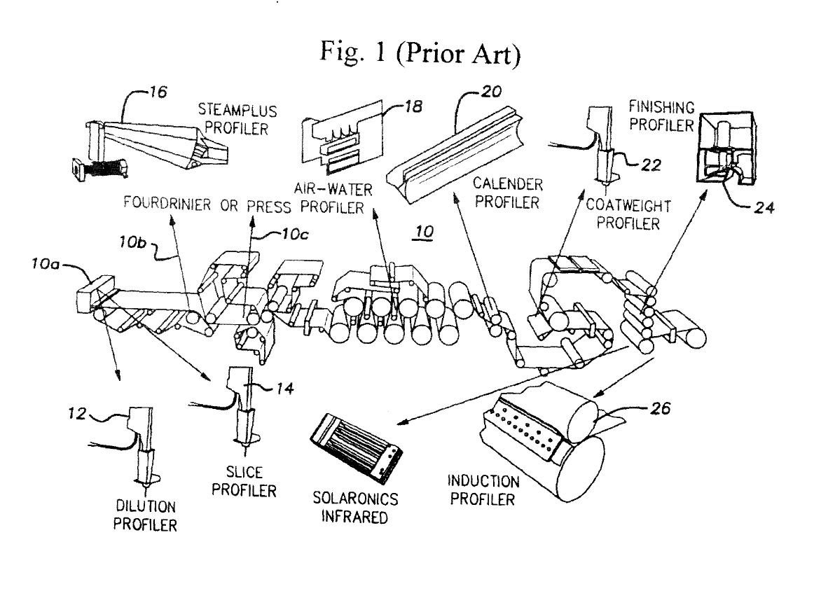

Referring now to FIG. 1, there is shown a typical papermaking machine 10 and various actuator driven profilers 12, 14, 16, 18, 20, 22, 24 and 26 that may be used on machine 10. More specifically, machine 10 as is well known to those of ordinary skill in the art will include an actuator driven dilution profiler 12 and an actuator driven slice profiler 14 associated with headbox 10a. The headbox 10a feeds a pulp suspension onto the initial part of a lower wire (not shown in FIG. 1). The actuator driven profilers 12 and 14 and others of the actuator driven profilers described herein are used to control the transverse profile of the suspension.

Papermaking machine 10 also includes a Fourdrinier table 10b and a press section 10c that may include one or more actuator driven steam profilers such as profiler 16 of FIG. 1. Steam showers profilers such as profiler 16 are conventional profiling systems that work by selectively delivering steam onto the paper web during production. Profiling steam showers deliver a variable distribution of steam in zones across the paper web. The amount of steam passing through each zone of a steam shower is adjusted through an actuator located in that zone. They are used to control both the overall moisture level and the moisture content of the sheet.

Further downstream machine 10 may also include an actuator driven air water profiler 18, a calender profiler 20, a coat weight profiler 22, a finishing profiler 24 and an induction profiler 26. Profiling steam showers, such as calender profiler 20, are also used in the calendering process to improve gloss and smoothness of the paper products. Moisture spray systems, such as air water profiler 18, are also conventional profiling systems normally used in the evaporating sections of papermaking machines. The induction profiler 26 has one or more workcoils that are used to heat the paper roll to provide caliper and gloss control.

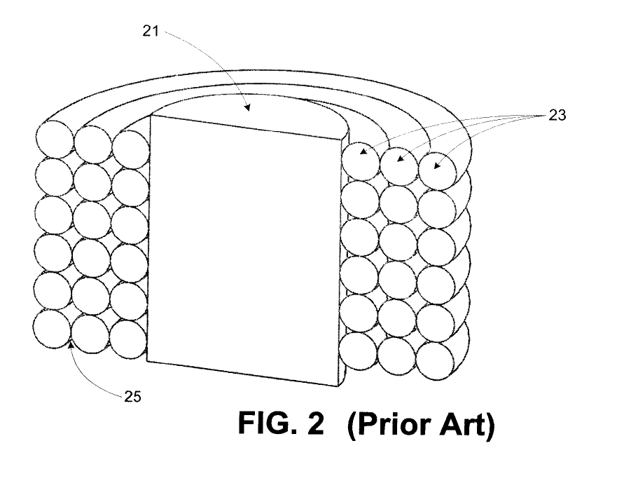

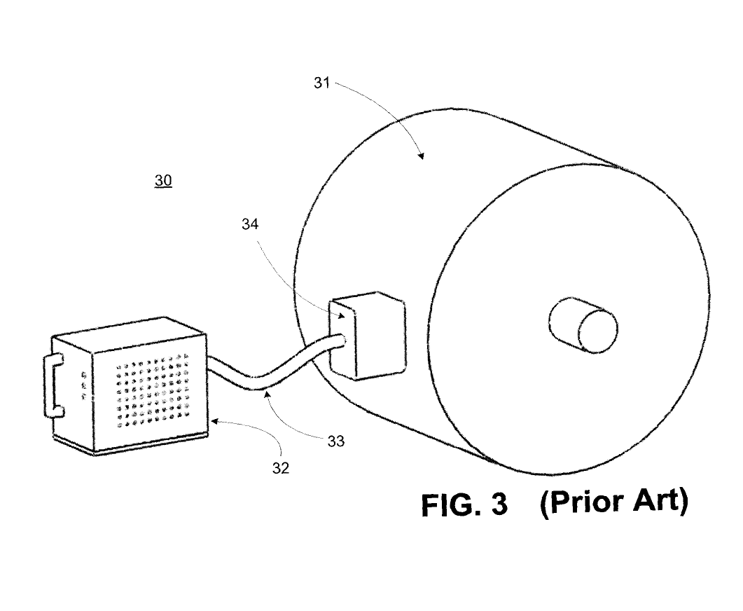

Referring now to FIG. 2, there is shown a cut away of a typical prior art workcoil positioned in the vicinity of a target material 31 shown in FIG. 3 to be heated by magnetic induction. The workcoil has three or more layers of conductive material 23 which are on a ferromagnetic core 21. The workcoil shown in FIG. 2 has three such layers. The gap between layers 25 is non-existent and thus the inner and intermediate layers are subjected to high temperatures.

FIG. 3 shows a typical induction heating system 30 in which the workcoil may be used. One or more power converters 32 are used with a matching number of workcoils 34 to control the heating parameters of a target roll 31. Each converter 32 is connected by power cable 33 to its matching workcoil 34. For ease of illustration, FIG. 3 shows only one power converter 32 connected by power cable 33 to its associated workcoil 34. Usually the system 30 is, as is well known to those of ordinary skill in this art, connected to a process controller not shown so that the parameters are precisely controlled. When used with multiple coils and converters, it is possible to perform local control processing such as Cross-Direction (CD) control on heated rolls, thus eliminating many of the variables introduced by traditional heating methods.

As is also well known, the target roll 31 has a conductive shell (not shown in FIG. 3) that generally represents the portion of the roll 31 that contacts a paper sheet or other product being formed. The conductive shell or the roll 31 could be formed from any suitable material(s), such as a metallic ferromagnetic material. The workcoil 34 operates to produce a current in an associated area or zone of the conductive shell of roll 31. The current could also be produced in different areas or zones of the roll 31, such as when the roll 31 is solid. The amount of current flowing through the zones could be controlled by controlling the power source 32 to adjust the amount of energy flowing into the coils of the induction heating workcoil 31. This control could, for example, be provided by the process controller.

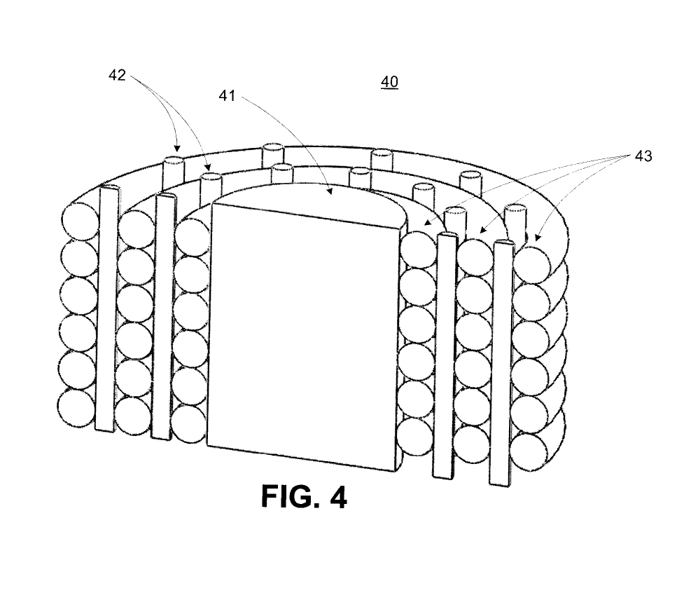

Referring now to FIG. 4, there is shown a multilayered workcoil 40 that can be positioned in the vicinity of a target material such as roll 31 that is to be heated by magnetic induction. Multiple layers 43 of conductive material are wound on a ferromagnetic core 41 to form the windings of workcoil 40. Solid thermal conductors 42 that have a thermal conductivity many times that of air are inserted, in the manner described below, between the layers 43. The solid thermal conductors 42 are the opposite of low thermal conductivity air cooled tubes or ducts that we have found will not provide the cooling needed for induction heating workcoils. The solid thermal conductors 42 are positioned at 90° to the orientation of the workcoil layers 43 thereby eliminating concerns that the conductors 42 will form secondary windings.

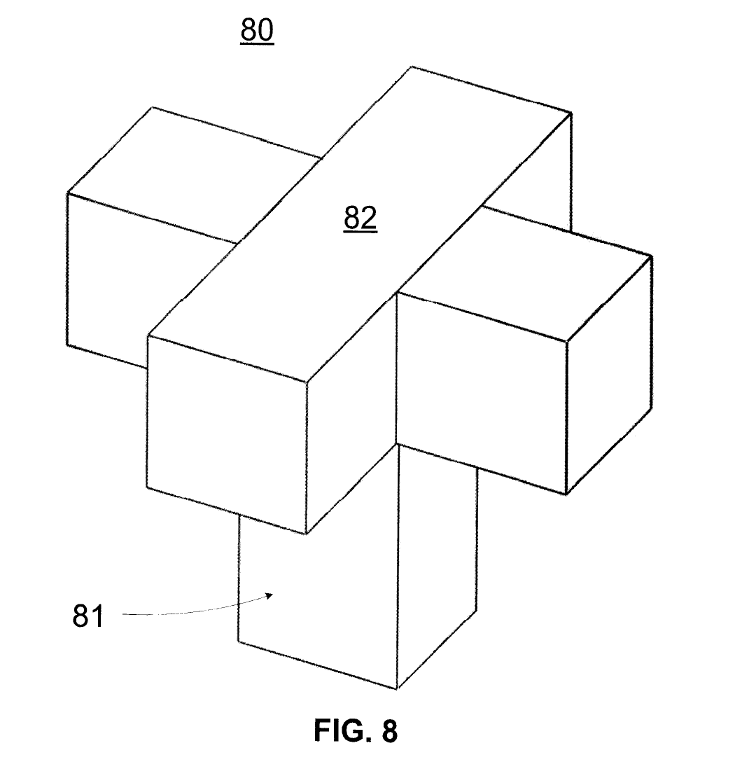

The core 41 shown in cutaway in FIG. 4 is actually the I-shaped leg of a core that has a cross-shaped top. One example of such a core is shown as the core 80 in FIG. 8 and described below. The core 41 is shown in simplified form in FIG. 4 so that the thermal conductors 42 can be more easily seen.

The solid thermal conductors 42 act as heat channels to provide a path for the temperature generated in the conductive layers 43 to be exhausted to the surface of workcoil 40. The heat channels 42 can be of various solid forms or materials, typically a round or rectangular conductive material. The workcoil windings 43 are tightly wound on the channels 42 so that the thermal interface is maximized. The chosen material of the channels 42 must not interfere with the induction heating process nor be affected by it. It is preferable as is shown in FIG. 4 to have the heat channels 42 longer than the coil itself, so that the heat can effectively be transferred away from the coil windings 43.

In one embodiment of the workcoil 40 shown in FIG. 4, the solid heat channels 42 that have a thermal conductivity many times that of air are made from Litz braided copper cable. By using flat cable for channels 42, the thermal interface between the layers 43 and the heat channels 42 is optimized. The flat cable also decreases the overall winding size, making the heat pattern narrower, thus contributing to higher power density.

The thermal conductivity of the Litz copper spacers is many times that of the air, typically 10,000 times more. As an example, the thermal conductivity of air at 125° C. is 0.034 W/m° K compared to 400 W/m° K for copper. The preferred shape of the copper spacers is a flat braided wire, increasing the area of contact between the windings and the spacers, while minimizing the gap where there are no spacers. This design allows the operation of this apparatus with roll or target surface temperatures exceeding 130° C., where traditionally, liquid cooled coils had to be used.

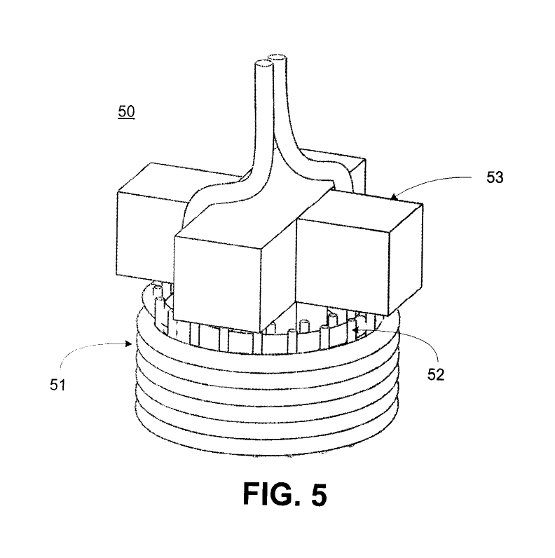

FIG. 5 shows an internal view of another embodiment 50 for the multilayered workcoil. Each of the multiple coil layers 51 of conductive material are wound on the I-shaped leg of a core 53 with a cross-shaped core which is shown in more detail as core 80 in FIG. 8. The gap between the layers 51 is filled with a spacer 52 made from a solid thermally conductive material. The thermally conductive material of spacer 52 channels the heat away from the layers 51. As is shown in FIG. 5, the spacers 52 are positioned at 90 degrees with respect to the coil layers 51 and are longer than the coil so that the heat can be effectively transferred away from the coil layers 51.

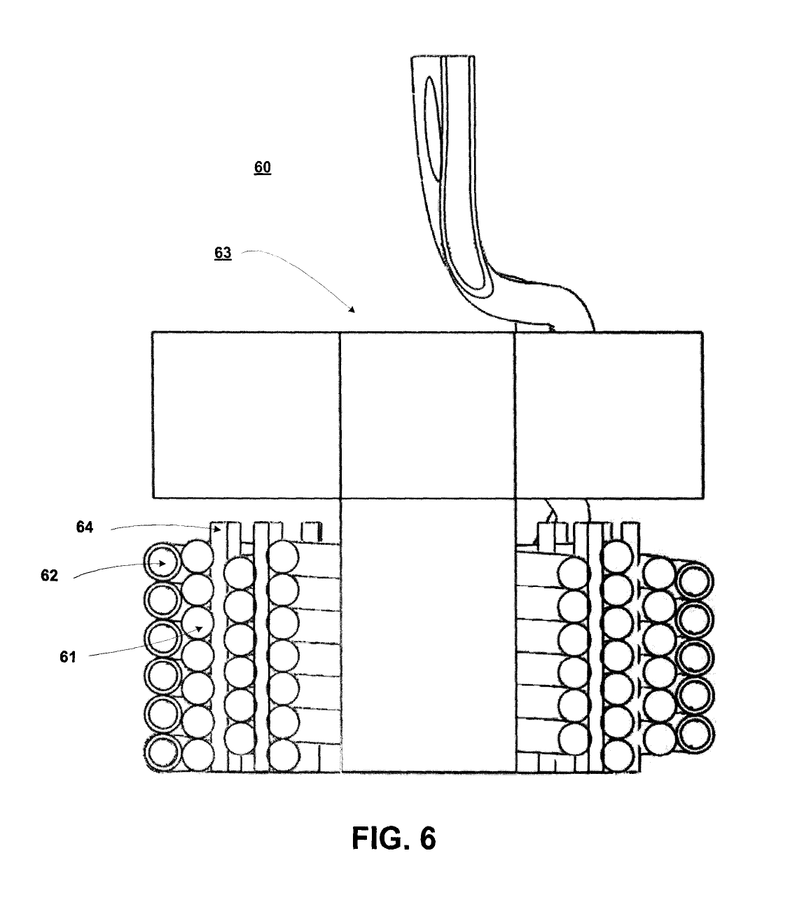

In another embodiment shown in FIG. 6, the windings 61 of induction workcoil 60 are wound on a core 63 that is the cross-shaped core 80 shown in FIG. 8. The gap between the layers 61 is filled with a spacer 64 made from a solid thermally conductive material. The spacer is positioned at 90 degrees with respect to the windings 61. When the induction workcoil 60 is used with very high surface temperatures (>150° C.), a tube 62 of Teflon, copper or other material are wound either around the whole windings 61, that is on the outside of those windings, or used as heat channels in between the windings. As can be appreciated, winding a thermally conductive but magnetically unresponsive tube 62 around the outside of the windings 61 greatly minimizes the electrical coupling of tube 62 with the windings 61. The heat is then carried away through a liquid circulating in the tube 62. Usually, water or glycols are used as coolants.

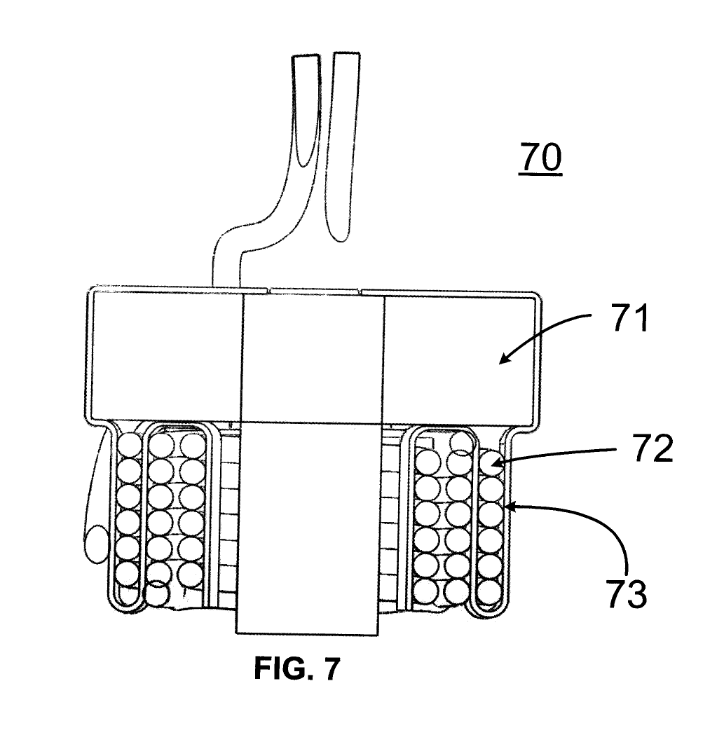

Referring now to FIG. 7, there is shown another embodiment for an improved induction heating coil 70. In this embodiment, the solid spacers are continuous Litz braids 73 and the conductive channels are inserted between the innermost layer 72 and the ferrite core 71 that is the cross-shaped core 80 shown in FIG. 8. As is shown in this figure, the Litz braids 73 are extended to the cross-shaped top of the soft ferrite core which further improves heat transfer away from the coil winding.

FIG. 8 shows the preferred ferrite core 80 for the embodiments shown in FIGS. 4 to 7. As shown in FIG. 8, the preferred core 80 is a soft ferrite core which has an I-shaped leg 81 on which the coil windings 43 of FIG. 4, 51 of FIG. 5, 61 of FIGS. 6 and 72 of FIG. 7 are placed and a cross-shaped top 82. The soft ferrite core 80 is shaped from a soft ferrite I core.

The cross-shaped arrangement for core 80 closes the magnetic flux path and improves the flux pattern distribution. The cross-shaped top 82 of the arrangement refocuses the flux lines which gives increased flux density and thus increased power density in the area close to the work piece, which for example may be the roll, such as roll 31 of FIG. 3, to be heated by the workcoil. With the cross-shaped arrangement, flux lines are distributed equally on both axes. The flux lines travel between the bottom end of the I Core and split evenly in all four points of the cross-shaped top ferrite 82. The cross shaped top ferrite 82 covers the coil windings outside dimensions so that the flux lines travel through the ferrite core as much as possible, without needlessly increasing the size of the apparatus. In this arrangement, the coil is not affected by various roll diameters or material shapes, as long as the size of the target piece is substantially larger that the bottom I

Core end area.

The heat channels 42 shown in FIG. 4, the spacers 52 shown in FIG. 5, the tubes 62 shown in FIG. 6 and the continuous Litz braids 73 shown in FIG. 7 each keep cool their respective coils 43, 51, 61 and 72. The cooling of these coils is not only beneficial to the reliability of the coil itself but also increases the coil efficiency. Typically the soft ferrite materials such as those for used for the core 80 shown in FIG. 8, obtain a peak efficiency around 70° C., plateau at about 110° C. and degrade until the Curie point is reached at 220° C. By keeping the coil cooler by using the heat channels 42 or the spacers 52, or the tubes 62 or the continuous Litz braids 73, the ferrite parameters such as flux density saturation level of core 80 and its permeability are kept at their peak efficiency levels. Thus the combination of the cross shaped soft ferrite core 80 and the heat channels 42 or the spacers 52 or the tubes 62 or the continuous Litz braids 73 allows for an increased power density in the area close to the work piece without having to increase coil winding size which would adversely affect the power density.

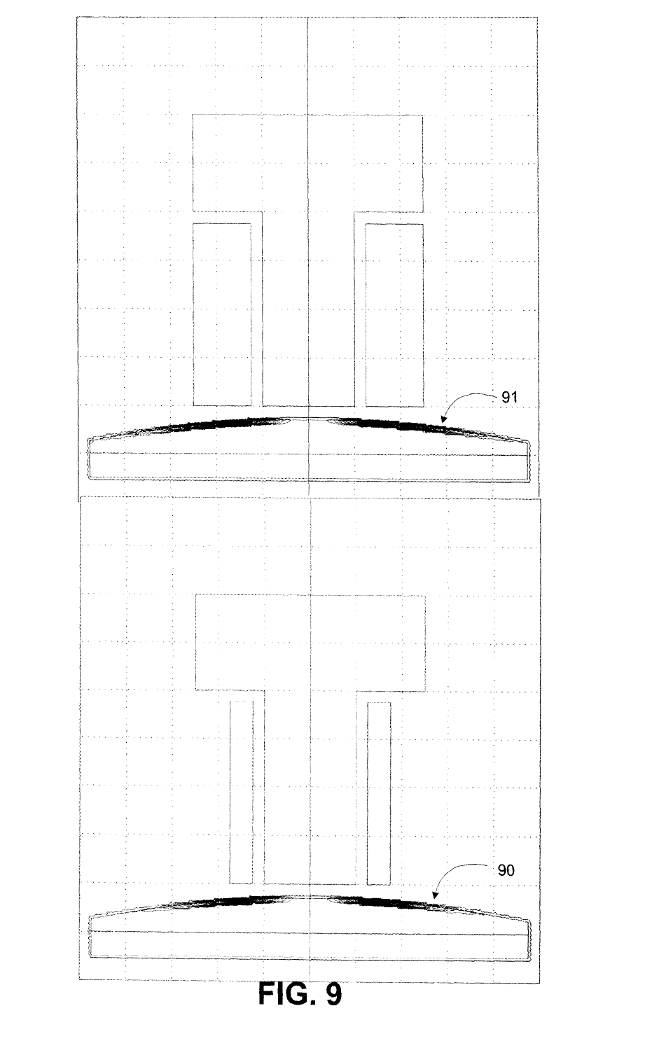

FIG. 9 illustrates how coil winding size affects the heating effect on the target material. When the coil size is increased, the heat is distributed to a larger area 91 than when then coil is narrower 90. Thus the larger coils 91 have less power density than the smaller coil 80 delivering the same power.

The workcoils 40 of FIG. 4, 50 of FIG. 5, 60 of FIGS. 6 and 70 of FIG. 7 are each encapsulated in epoxy resin which acts to prevent chemical and mechanical damage. To achieve the desired heating effect, the power converter attached to the workcoil will apply high voltage and the epoxy also acts as an electrical insulator. While the epoxy also helps to carry heat away from the windings 43 shown in FIG. 4, the windings 51 shown in FIG. 5, the windings 61 shown in FIG. 6 and the windings 72 shown in FIG. 7, its effectiveness is much lower than the heat channels 42 shown in FIG. 4, the spacers 52 shown in FIG. 5, the tubes 62 shown in FIG. 6 and the continuous Litz braids 73 shown in FIG. 7. In each of the embodiments shown in FIGS. 4-7, the epoxy layer is at least six (6) mm, but kept below 10 mm.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. An induction heating coil comprising:
a winding of multiple layers of an electrically conductive material wound on a ferrite core; and
solid thermal conductors between said multiple layers of said winding to provide a thermal interface with said multiple layers for cooling said conductive material.

2. The induction heating coil of claim 1 wherein said solid thermal conductors extend beyond the height of said winding to thereby conduct heat from said winding multiple layers to a top portion of said ferrite core.

3. The induction heating coil of claim 1 wherein said ferrite core comprises an I-shaped leg with a cross-shaped top and said winding multiple layers are wound on said leg.

4. The induction heating coil of claim 3 wherein said solid thermal conductors extend beyond the height of said winding to thereby conduct heat from said winding multiple layers to said cross-shaped top of said ferrite core.

5. The induction heating coil of claim 1 wherein said multiple layers of said winding are wound on said solid thermal conductors in a manner that maximizes said thermal interface.

6. The induction heating coil of claim 3 further comprising hollow tube thermal conductors that are wound around the outside of said multiple layers of said winding.

7. The induction heating coil of claim 3 wherein said multiple layers of said winding are wound on said leg in a manner that maximizes said thermal interface with said solid thermal conductors between said multiple layers of said winding.

8. The induction heating coil of claim 1 further comprising hollow tube thermal conductors that are wound around the outside of said multiple layers of said winding.

9. A system comprising:
an induction profiler for indirectly heating a non-conductive sheet of material, said induction profiler comprising:
one or more induction heating coils, each of said one or more induction heating coils comprising:
a winding of multiple layers of an electrically conductive material wound on a ferrite core; and
solid thermal conductors between said multiple layers of said winding to provide a thermal interface with said multiple layers for cooling said conductive material.

10. The system of claim 9 wherein said ferrite core of each of said one or more induction heating coils comprises a cross-shaped top and an I-shaped leg protruding downwardly from a bottom surface of said top and said multiple layers of said winding are wound on said leg.

11. The system of claim 9 wherein said induction profiler further comprises a target roll having a conductive shell for contacting said non-conductive sheet of material to be indirectly heated by said one or more induction heating coils and each of said one or more induction heating coils is associated with said target roll to generate magnetic fluxes in said roll.

12. The system of claim 9 further comprising one or more power supplies for supplying electrical power to an associated one of said one or more induction heating coils.

13. The system of claim 11 wherein said target roll comprises one of a set of counter-rotating rolls configured to compress said non-conductive sheet of material and one or more induction heating actuators each comprising an associated one of said one or more induction heating coils and an associated one of one or more power supplies for supplying electrical current to said associated one of said one or more induction heating coils.

14. The system of claim 9 wherein said non-conductive sheet of material is a paper web.

15. The system of claim 12 further comprising one or more cables adapted to carry electrical power for connecting each of said one or more power supplies to said associated one of said one or more induction heating coils.

16. A ferrite core for use in an induction heating workcoil, said core comprising a cross-shaped top with a bottom surface and an I-shaped leg protruding downwardly from said bottom surface of said top.

17. The ferrite core of claim 17 further comprising a winding of multiple layers of an electrically conductive material wound on said leg.
